(19) United States
(12) Patent Application Publication
(10) Pub. No.: US 2006/0124110 A1
(43) Pub. Date: Jun. 15, 2006

(54) Connection of two coaxially in-line elements in a fuel supply system of an internal combustion engine

(76) Inventor: Jochen Schoeffler, Murr (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/347,268

(22) Filed: Feb. 6, 2006

Related U.S. Application Data
(63) Continuation of application No. 10/275,313, filed on Nov. 5, 2002.

(30) Foreign Application Priority Data
Mar. 13, 2001 (DE) 201 04 270.3

(51) Int. Cl. F02M 69/54

(52) U.S. Cl. 123/457

(57) ABSTRACT

The invention relates to a connection of two coaxially in-line elements in a fuel supply system of an internal combustion engine, in which the first element is preferably a receiving bush of a fuel distributor line with a guide opening, and the second element, embodied as a pressure regulating valve or pressure chamber, is insertable by a guide portion into the guide opening of the receiving bush, which facing one another in a wall has two retention openings, aligned both with one another and with a retention groove in the pressure regulating valve, which openings a U-shaped retention clamp projects through with its legs and in so doing fixes the position of the first element and second element relative to one another, which elements, at least in the region of the retention clamp have portions of stainless steel. Alternatively, the first element may be an injection valve, which is inserted by one end into a plug connection, forming the second element, of the fuel distributor line, where it is fixed by means of a securing clamp, and the injection valve and the plug connection, at least in the region of the securing clamp, have portions of stainless steel. The invention provides that the retention clamp is formed by a spring wire and the securing clamp is formed of a spring band of stainless steel, in order to prevent contact corrosion.

### CROSS-REFERENCE TO RELATED APPLICATIONS

This application is a continuation of prior application Ser. No. 10/275,313, which was the National Stage of International Application No. PCT/DE 02/00892, filed on Mar. 13, 2002.

### BACKGROUND OF THE INVENTION

1. Field of the Invention

The invention is based on a connection of two coaxially in-line elements in a fuel supply system of an internal combustion engine.

2. Description of the Prior Art

From German Patent Disclosure DE 36 07 811 A1, a connection is known which is used for fixing a pressure regulating valve in a receiving bush that extends transversely to a fuel distributor line of a motor vehicle and which has a through bore that is in communication with an inlet opening of the fuel distributor line. To that end, a bottom part of the pressure regulating valve is inserted into the through bore of the receiving bush, which has two slots, facing one another in a wall and aligned both with one another and with a retention groove in the pressure regulating valve; a U-shaped retention clamp embodied as a spring element projects with its legs through the slots, and as a result a prestressing force that keeps the pressure regulating valve in the receiving bush can be generated.

Also known from the prior art are securing clamps for fastening injection valves to plug connections in a fuel distributor line.

The retention clamps and securing clamps in the prior art are stamped and bent parts made of spring steel, especially CK67, which are subsequently provided with a corrosion protection, for instance by zinc plating and yellow chromating. However, the corrosion protection layer is often damaged in the assembly of the retention and securing clamps, so that because of the damage and because of electrochemical reactions, contact corrosion occurs between the steel of the elements connected to one another and the spring steel, which in some points is unprotected and is not made of such special material, that comprises the retention clamps and securing clamps, and in the worst case this causes breakage and complete failure of these components.

### SUMMARY OF THE INVENTION

The connection according to the invention has the advantage over the prior art that because of the use of stainless steel for the retention clamp and the securing clamp, the materials are of the same type in terms of the elements connected to one another by these components. Consequently electrochemical reactions between the retention clamp or securing clamp on the one hand and the elements connected to one another by them in the fuel supply system on the other are largely precluded. In particular, it is possible to dispense with such additional corrosion protection provisions as painting, yellow chromating, or zinc plating.

Serving as the first element in the connection of the invention is for instance a receiving bush, connected to a fuel distributor line, into which a pressure regulating valve is inserted as the second element. The legs of the retention clamp at least in some portions form circular curves that enclose an imaginary circular area and at least in some portions are shaped to be complementary to a cylindrical retention groove of the pressure regulating valve. Before being inserted into the retention openings, the legs are curved toward one another in such a way that the circular area enclosed by the circular curves has a smaller radius than the retention groove. This means that the retention clamp is seated with radial prestressing in the retention groove and is thus secure against being shaken loose. To reduce any material stresses that may be caused by this, the retention clamp can be tempered after being pre-bent and before being inserted into the retention openings.

### BRIEF DESCRIPTION OF THE DRAWINGS

Exemplary embodiments of the invention are described in further detail in the ensuing description, in conjunction with the drawings, in which:

FIG. 1, a cross-sectional view through a connection of a pressure regulating valve to a fuel distributor line;

FIG. 2, a second taken along the line II-II of FIG. 1;

FIG. 3, a side view of the securing clamp;

FIG. 4, an end view of the securing clamp of FIG. 3; and

FIG. 5, a top view on the securing clamp of FIG. 3.

### DESCRIPTION OF THE PREFERRED EMBODIMENTS

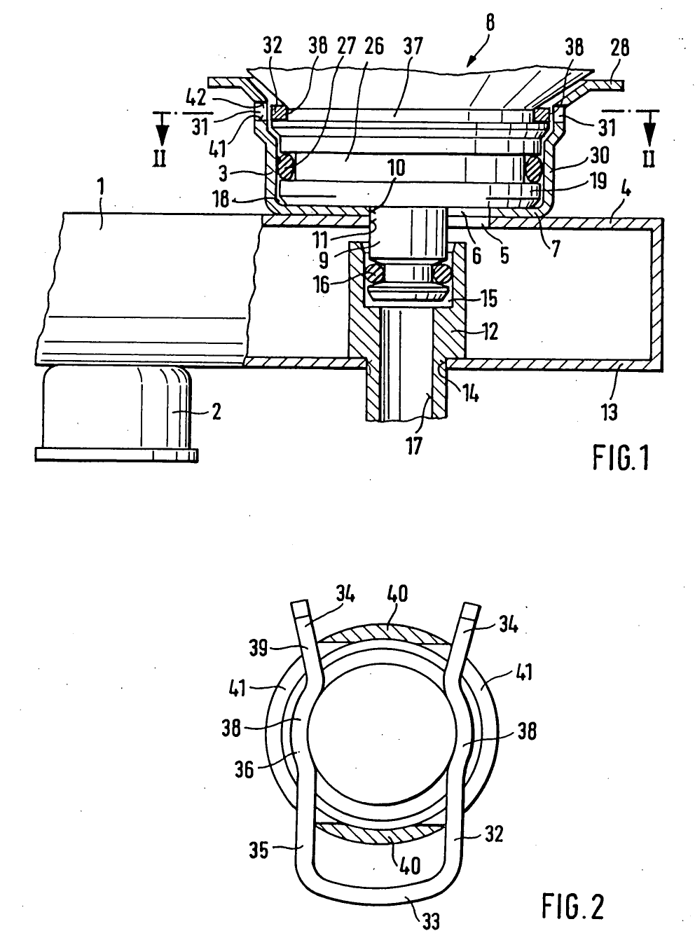

In the exemplary embodiment of FIG. 1 and FIG. 2, reference numeral 1 indicates a fuel distributor line in a fuel supply system for internal combustion engines; this line has a plurality of plug connectors 2, into which fuel injection valves are inserted by one end. A cup-shaped receiving bush 3 is connected, for instance by being soldered or welded, to the wall of the fuel distributor line 1. The receiving bush 3 can also be formed onto the fuel distributor line I and/or can project at least partway into the fuel distributor line 1. At least one inlet opening 5 is provided in the wall 4, toward the receiving bush 3, of the fuel distributor line 1, and this opening is aligned with a connecting opening 6 in the bottom 7 of the receiving bush 3. The inlet opening 5 and the connecting opening 6 can also have an annular shape. A pressure regulating valve 8 is inserted into a guide sleeve portion 18 of the receiving bush 3; with a valve seat carrier body 9, it projects through a first push-through opening 10 in the receiving bush 3 and a second push-through opening 11 in the wall 4 of the fuel distributor line 1 into an outlet stub 12 in sealing fashion. The outlet stub 12 projects into the fuel distributor line 1 and penetrates the wall 13, remote from the pressure regulating valve 8, of the fuel distributor line 1 in an opening 14, in which it is secured tightly, for instance being soldered. Instead of through the separate push-through openings 10, 11, the inlet openings 5 and the connecting opening 6 can also be embodied as so large that the valve seat carrier body 9 can be passed by its circumference through the inlet opening 5 and the connecting opening 6 while maintaining a sufficiently large cross section. The valve seat carrier body 9 projects, with its end protruding out of the pressure regulating valve 8, into a receiving bore 15 of the outlet stub 12 and is provided on its circumference with an elastic sealing ring 16 to provide sealing off from the receiving bore 15. An outlet conduit 17 which projects in the axial direction through the outlet stub 12, also penetrates the valve seat carrier body 9 in a manner not shown, and leads to a fuel tank or to the intake side of a fuel feed pump. The fuel distributor line 1 communicates with a fuel supply line, not shown for reasons of scale, which is connected to the pumping output of the fuel pump. The inlet opening 5 and the connecting opening 6 form one part of an inlet conduit for the fuel into the pressure regulating valve 8. The mode of operation of such a pressure regulating valve is known, for instance from German Patent Disclosure DE 36 07 811 A1, and will therefore not be discussed further here.

The valve housing of the pressure regulating valve 8 has a bottom part 19, which is inserted into the receiving bush 3 and has the valve seat carrier body 9, which is either joined as an independent part to the bottom part 19 or is part of the bottom part. The bottom part 19, on its circumference, has a radially open sealing groove, in which a sealing ring 27 that provides sealing in the radial direction is disposed. The receiving bush 3 surrounds the bottom part 19 of the pressure regulating valve 8, extending in the axial direction from the bottom 7, in one region at least so completely that secure sealing between the bottom part 19 and the receiving bush 3 is assured by the sealing ring 27. The receiving bush 3, on its end remote from the fuel distributor line 1, has a radially outward-extending flange 28, which extends approximately parallel to the fuel distributor line 1. Two slots 31 facing one another and extending circumferentially are embodied in a wall 30 of the receiving bush 3. For axially fixing the pressure regulating valve 8 to the receiving bush 3, a retention clamp 32 is used.

The slots 31 in the wall 30 of the receiving bush 3 represent retention openings for the U-shaped retention clamp 32. The retention clamp comprises spring wire of stainless steel in accordance with DIN 17224, which has a chromium content of at least 12% and in particular also a nickel content of at least 6%. For instance for the retention clamp 32, spring wire of X 12 Cr Ni 17 7 (material number 1.4310) is used. As best seen from FIG. 2, the retention clamp 32 has two legs 34, joined by a crossbar 33, which extend parallel to one another in the region of an initial portion 35 that adjoins the crossbar 33 and then, in a middle portion 36, form circular curve segments 38 that define an imaginary circular area and are shaped to be complementary to a cylindrical retention groove 37 of the pressure regulating valve 8; the circular curve segments open into an end portion 39, in which the legs 34 diverge in funnel-like fashion. In the inserted state, the retention clamp 32 is radially prestressed against the retention groove 37, which is achieved for instance by providing that the legs are curved toward one another before assembly in such a way that the circular area that they define has a smaller radius than the retention groove 37. To reduce the material stresses resulting from the pre-bending process, the retention clamp 32 is preferably subsequently tempered, although because the degree of deformation is only slight this is often not necessary. The retention clamp 32 is preferably a flat component; that is, its legs 34 are located in the same plane. Alternatively, corrugations may be formed onto the circular curves 38 of the middle portion 36, and these corrugations extend in a plane that is perpendicular to a plane containing the retention groove 37. These corrugations may each be formed by an essentially single-period sine-wave curve, and the corrugation of one leg 34 may be phase-offset from the corrugation of the other leg 34, for instance by 180°.

When the pressure regulating valve 8 is inserted into the receiving bush 3, the two slots 31 in the receiving bush 3 are in alignment with the retention groove 37 embodied on the circumference of the pressure regulating valve 8. The inside height of the slots 31 is slightly greater than the diameter of the retention clamp wire, so that the retention clamp 32 can be inserted at a tangent into them, as best seen from FIG. 2. When the retention clamp 32 is inserted at a tangent into the slots 31 of the receiving bush 3, its legs 34 can therefore engage the retention groove 37 and run along its inside in the circumferential direction. The legs 34 initially spread open, which is facilitated by the end portion 39 that widens in funnel-like fashion, until they snap with the circular curves 38 of the middle portion 36 onto the retention groove 37 and grip the pressure regulating valve 8 on both sides by positive engagement.

The slots 31 that are present in the wall 30 of the receiving bush 3 extend in the radial direction so far into the receiving bush that two residual curved segments 40 remain that have a width which is essentially equivalent to the length of the crossbar 33, or to the spacing of the two legs 34 of the retention clamp 32 in their end portion 39. The retention clamp 32 is long enough that in the mounting position both its initial portion 35 with the crossbar 33 and its end portion 39 that widens in funnel-like fashion each project at least partway out of the slots 31, so that the legs 34 in the region of the slots 31 intersect end faces 41, 42, located there and extending essentially parallel to the plane of the retention clamp and facing one another, in the wall 30 of the receiving bush 3. Consequently the retention clamp 32 can be braced in the slots 31 of the receiving bush 3, and as a result a retention force is generated that holds the pressure regulating valve 8 on the bottom 7 of the receiving bush 3.

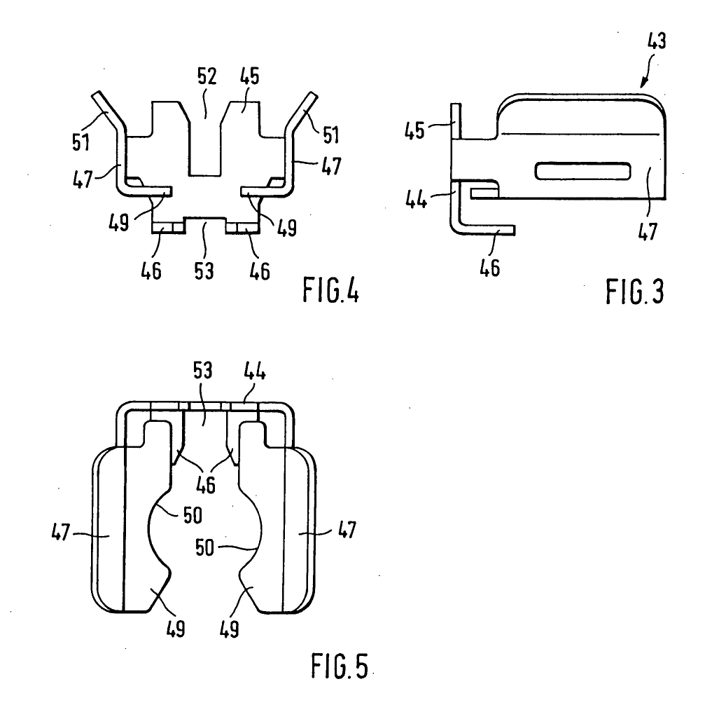

In the exemplary embodiment of FIG. 3, a securing clamp 43 for fastening an injection valve to the plug connector 2 of the fuel distributor line 1 is shown. The securing clamp 43 has an L-shaped top plate 44 with two legs 45, 46 perpendicular to one another, from one leg 45 of which two symmetrical wings 47 project at right angles. As best seen in FIGS. 4 and 5, the wings 47 have portions 49, extending parallel to the other leg 46 of the top plate 44, with free edges pointing toward one another that form circular curved surfaces 50 that partly enclose an imaginary circular area. Portions 51, perpendicular to the circular curved surfaces 50, of the wings 47 extend initially parallel to one another, viewed in the direction toward the free end of the one leg 45 of the top plate 44, and then diverge in funnel-like fashion, as FIG. 4 shows. In each of the two legs 45, 46 of the top plate 44, there is also a respective central blind slot 52, 53, originating at the free end of the respective leg 45, 46.

The securing clamp 43 comprises spring band or sheet of stainless steel according to DIN 17224, which has a chromium content of at least 12% and in particular also a nickel content of at least 6%. For instance, spring band comprising X 12 Cr Ni 17 7 (material number 1.4310) is used, for instance, for the securing clamp.

The foregoing relates to preferred exemplary embodiments of the invention, it being understood that other variants and embodiments thereof are possible within the spirit and scope of the invention, the latter being defined by the appended claims.

I claim:

1. In a connection of two coaxially in-line elements in a fuel supply system of an internal combustion engine, in which the first element has a guide sleeve, and the second element is insertable by a guide portion into the guide sleeve of the first element, which first element has, facing one another in a wall, two retention openings aligned with one another and with a retention groove in the second element, which openings a U-shaped retention clamp projects through with its legs and in so doing fixes the position of the first element and second element relative to one another, which elements, at least in the region of the retention clamp have portions of stainless steel, wherein the retention clamp is formed by a spring wire of stainless steel and the portions of the first element and the second element, at least in the region of the retention clamp, and the retention clamp comprise materials of the same type, to avoid electrochemical reactions between the retention clamp and the portions of the first element and the second element in the region of the retention clamp.

2. The connection of claim 1 wherein the first element is a receiving bush, connected to a fuel distributor line, and wherein the second element is a pressure regulating valve inserted into the receiving bush.

3. The connection of claim 1 wherein the first element is a receiving bush, connected to a fuel distributor line, and wherein the second element is a pressure chamber inserted into the receiving bush.

4. The connection of claim 2 wherein the legs of the retention clamp, at least in some portions, form circular curved segments that define an imaginary circular area and are shaped to be complementary to a cylindrical retention groove of the pressure regulating valve.

5. The connection of claim 3 wherein the legs of the retention clamp, at least in some portions, form circular curved segments that define an imaginary circular area and are shaped to be complementary to a cylindrical retention groove of the pressure chamber.

6. The connection of claim 4 wherein the legs of the retention clamp, before being inserted into the retention openings, are curved toward one another in such a way that the imaginary circular area defined by the circular curved segments has a smaller radius than the retention groove.

7. The connection of claim 5 wherein the legs of the retention clamp, before being inserted into the retention openings, are curved toward one another in such a way that the imaginary circular area defined by the circular curved segments has a smaller radius than the retention groove.

8. The connection of claim 6 wherein, after pre-bending and before being inserted into the retention openings, the retention clamp is tempered.

9. The connection of claim 7 wherein, after pre-bending and before being inserted into the retention openings, the retention clamp is tempered.

10. In a connection of two coaxially in-line elements in a fuel supply system of an internal combustion engine, in which the first element is an injection valve, which is inserted by one end into a plug connection, forming the second element, of a fuel distributor line and is fixed there by means of a securing clamp, and the injection valve and the plug connection, at least in the region of the securing clamp, have portions of stainless steel, wherein the securing clamp comprises stainless steel spring band and the portions of the injection valve and of the plug connection, at least in the region of the securing clamp, and the securing clamp comprise materials of the same type, to avoid electrochemical reactions between the securing clamp and the portions of the injection valve and of the plug connection in the region of the securing clamp.

11. The connection of claim 10 wherein the securing clamp includes an L-shaped top plate with two legs perpendicular to one another, from whose one leg two symmetrical wings project at right angles, which wings have portions, extending parallel to the other leg of the top plate, the portions having free edges pointing toward one another, which form circular curves enclosing an imaginary circular area, and to that end perpendicular portions of the wings, viewed in the direction toward the free end of the one leg of the top plate, initially extend parallel to one another and then widen in funnel-like fashion, and in both legs of the top plate, a respective central blind slot is embodied, originating at the free end of the respective leg.

12. The connection of claim 1 wherein the stainless steel spring wire has a chromium content of at least 12% and a nickel content of at least 6% in accordance with DIN 17224, and in particular comprises X 12 Cr Ni 17 7, material number 1.4310.

13. The connection of claim 10 wherein the stainless steel spring band has a chromium content of at least 12% and a nickel content of at least 6% in accordance with DIN 17224, and in particular comprises X 12 Cr Ni 17 7, material number 1.4310.
